(19) United States
(12) Patent Application Publication
(10) Pub. No.: US 2013/0325753 A1
(43) Pub. Date: Dec. 5, 2013

(54) Comprehensive and standardized method of estimating pricing for repair of automobile dent damage by Paintless Dent Repair (PDR) and/or Push-to-Paint (PTP) techniques

(71) Applicants: James W. Sullivan, Centerville, TN (US); Jack Darren Pelham, Tallahassee, FL (US)

(72) Inventors: James W. Sullivan, Centerville, TN (US); Jack Darren Pelham, Tallahassee, FL (US)

(21) Appl. No.: 12/806,198

(22) Filed: Sep. 16, 2009

(51) Int. Cl. G06Q 30/02

(52) U.S. Cl. CPC G06Q 30/0283
USPC 705/400

(57) ABSTRACT

A computer-based system, method and computer program product for estimating the repair costs for paintless dent removal and ready-to-paint dent repair for irregular dents in automobiles, which includes a user interface, a dent estimator database and computer program that matches variable information received from a user with corresponding values in the dent estimator database and calculates an estimated cost for repair of dents on an automobile. The system, method and product allows an untrained person to accurately estimate the cost of paintless dent repair for irregular shaped dents.

### CROSS-REFERENCE TO RELATED APPLICATION

The present application claims priority benefit of U.S. Provisional Application No. 61/242,931, filed Sep. 16, 2009, which is herein incorporated by reference in its entirety.

### BACKGROUND OF THE INVENTION

The present invention relates generally to dent repair, and in particular to a system and method for estimating repair costs of paintless dent removal and ready-to-paint dent repair (both types of repair referred to herein as “PDR”) for irregular-shaped dents of various sizes (“Irregular Dents”). PDR has become something of a standard for repair of damage to vehicle surfaces caused by hail or icy precipitation, which dents generally are small, symmetrical and evenly distributed across the surface of a vehicle (“Symmetrical Dents”), but has not been as widely adopted as an alternative repair method for Irregular Dents.

The value of a vehicle with either Irregular Dents or Symmetrical Dents can be severely decreased due to the damaged appearance of the vehicle, as well as the relatively high costs of traditional repair methods.

One traditional dent repair method involves complete replacement of damaged panels followed by finishing (i.e., priming, sanding, painting, and clear coating) of the newly-replaced panels. Another traditional dent repair method requires filling in a dent with a hardening fill material (e.g., Bondo®), which is then sanded, prepared for painting and painted. These methods are expensive both in terms of labor and materials, which often results in the cost of repairing Irregular Dents and Symmetrical Dents being disproportionately high when compared to the actual value of the damaged vehicle.

PDR involves actually removing a dent from the damaged panel using any number of specialized tools, including, without limitation, elongated tools and picks; which are used to push or force the dent out of the damaged panel. Often the existing paint will remain adhered to the panel, and the repaired panel will not require refinishing.

Unlike traditional repair methods, the predominant cost of PDR is in the physical labor required to remove the dent, as there are usually no replacement parts. As labor is generally the most difficult portion of any repair job to estimate, the estimate becomes especially important in PDR.

The difficulties of PDR estimation have been overcome for Symmetrical Dents primarily due to the fact that after a hail storm, numerous vehicles are damaged across a geographical region. Under these circumstances, it is economically practical for a trained PDR estimator to remain in a geographical location and estimate PDR repair costs for Symmetrical Dents due to the high volume of damaged vehicles in the area. This has resulted in the development and success of systems and methods for repairing Symmetrical Dents.

However, the challenges in estimating Symmetrical Dents are different than for Irregular Dents. Symmetrical Dent estimating systems rely primarily on the PDR estimator's ability to estimate the cost to repair numerous Symmetrical Dents based on the average size and estimated number of dents on the vehicle.

The estimating systems for Symmetrical Dents also tend to rely on the relatively uniform cost of repairing many hail-sized dents on a vehicle. By contrast, the difficulty in estimating Irregular Dents comes from the differences in sizes and shapes of the dents as well as the low quantity of dented vehicles in a geographic area. For example, a rural area may have only a small number of vehicles with Irregular Dents per day and not reach a sufficient volume to justify a full-time PDR estimator in that area. Additionally, Irregular Dents are inherently more difficult to repair than Symmetrical Dents and require more labor per dent to fix. which often requires a more experienced PDR estimator.

Systems for fixing Symmetrical Dents often require specialized measuring and estimating tools which either do not work well for estimating Irregular Dents or are simply unavailable to an average body shop or vehicle owner. Another complicating factor is that often the cost of estimating a single damaged vehicle by PDR is simply too low to justify the expense of connecting a PDR repair technician estimator with a single damaged vehicle. As a result of these factors, existing systems for fixing Symmetrical Dents have not translated well to Irregular Dent PDR, and traditional methods for repairing these dents persist even though they are actually more expensive and wasteful.

There is a need for a simple method and system for estimating the cost of repair of Irregular Dents that can be performed by an untrained person on an infrequent basis in order to lower the cost and uncertainty of estimating Irregular Dent PDR. This system should allow estimates to be done remotely by an insurance estimator, body shop, PDR repair technician, vehicle owner or other untrained individual (“Estimators”). Herein are embodiments for an invention directed to systems, methods, and computer program products for estimating the costs of repairing Irregular Dents with PDR.

### SUMMARY OF THE INVENTION

The present invention provides a simple computer-based system, method and computer program product (“System”) for estimating the repair costs for paintless dent removal and ready-to-paint dent repair for irregular Dents in automobiles, which includes a user interface, a dent estimator database and a computer program that matches variable information received from a user with corresponding values in the dent estimator database and calculates an estimated cost for repair of dents on an automobile. The System allows an untrained person to accurately estimate the cost of PDR for Irregular Dents. Currently available estimating systems are not well suited to Irregular Dents, and as a result PDR is often excluded as a repair option because of the difficulty in obtaining an accurate repair quote for Irregular Dents.

### BRIEF DESCRIPTION OF DRAWINGS

FIG. 1 is a flow chart of sample steps 1-17 performed by the System illustrating sample information and input used in estimating the costs to repair an Irregular Dent with PDR;

FIG. 2 is a flow chart of sample steps 18-28 performed by the System, illustrating sample information and input used in estimating the costs to repair an Irregular Dent with PDR;

FIG. 3 is an information table illustrating some difficulty factors that may be presented to an Estimator by the System in one embodiment of the invention;

FIG. 4 shows sample measurement options for estimating the width of a dent when an Estimator is using a System;

FIG. 5 is a exploded top two-dimensional view of panels comprising the body of a sample standard automobile with numbered panels identifying front, right, left, and rear panels; and

FIG. 6 is a sample spreadsheet representative of a dent estimator database used to provide the baseline repair pricing estimate data for the System.

### DETAILED DESCRIPTION

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

In one aspect of the present invention, a System allows an Estimator to enter the make and model of the vehicle, the location of the Irregular Dent on the vehicle, and the length and width of the Irregular Dent into such System, including, without limitation, through an Internet browser, desktop application, or mobile application, which System calculates the estimated cost to fix the Irregular Dent and returns the estimate to the Estimator.

The present invention may further comprise a System that applies difficulty factors to the estimate based on vehicle information obtained from a database of information about the vehicle or the vehicle's technician's manual, including, without limitation, the presence of a support brace behind the damaged panel, presence of double paneling, glue or other adhesive behind the paneling that must be removed/replaced, access restrictions to the inside of the panel, the difficulty of removing a headliner to gain access to the underside of the roof panel, the size of the panel, the type of metal in the panel, whether the dent crosses a body line of the vehicle, or existence of double paneling behind the dent.

In another aspect of the present invention the System allows the Estimator to enter additional difficulty factors about the Irregular Dent, including, without limitation, that the dent is creased, the dent is deeper than ordinary, or the dent is within an inch of the panel's edge.

In another aspect of the present invention, the System may communicate to the PDR technician (as well as the Estimator) the estimate and information about the estimate and the Irregular Dent.

In another aspect of the present invention, the System may communicate to the PDR technician specific instructions about the repair by accessing the applicable vehicle manual and providing the PDR technician with detailed instructions on making the repair, including, without limitation, instructions on removing and installing headliners without damaging them.

In another aspect of the present invention, the System may communicate to a body shop or other repair location comparative costs showing the difference in cost (or profit margin) between using PDR or traditional repair techniques.

In vet another aspect of the present invention, the System may schedule an appointment for a PDR technician to complete the repair.

In still another aspect of the present invention, the System accepts photos or images of the vehicle identification number and the Irregular Dent, which images are transmitted from a mobile device and identify the vehicle and location of the dent to be used in calculating the PDR estimate.

These and other advantages of the invention will he further understood and appreciated by those skilled in the art by reference to the following written specification. claims and appended drawing.

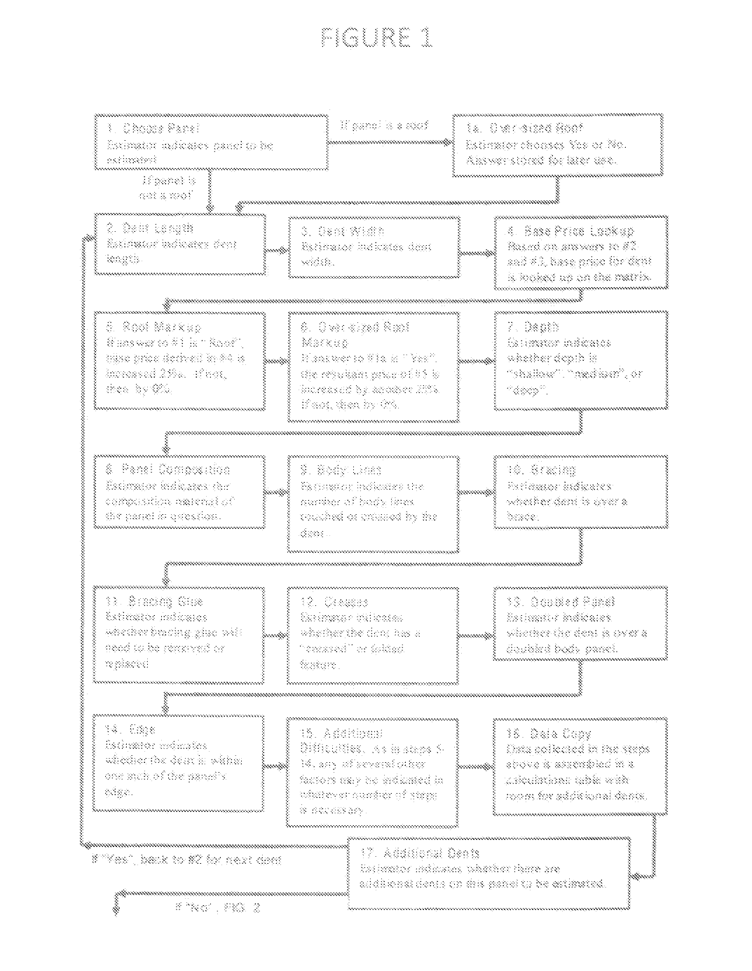

FIG. 1 is a flow chart of sample steps 1-17 performed by the System (defined below) illustrating sample information and input used in estimating the costs to repair an Irregular Dent with PDR. The steps one embodiment of the system may perform (and guide the Estimator to perform), as illustrated by FIGURE are: (Step 1) the Estimator inputs the location of the dent on the vehicle; (Step 1a) if the panel is a roof, the System prompts the Estimator to indicate whether the roof is oversized; (Step 2) the System then prompts the Estimator to measure and enter the length of the dent; (Step 3) the System then prompts the Estimator to measure and enter the width of the dent: (Step 4) based on the Estimator's entries for the length and width of the dent, the System calculates a base price estimate for the repair. Such System may then determine whether the panel selected was a roof and adds a cost percentage increase for difficulty. If the Estimator indicated that the roof was oversized. the System may add an additional percentage increase to the estimate for the additional difficulty (Step 5).

Once the System has calculated the base estimate, the System may prompt the Estimator about additional difficulty factors. including, without limitation, the following: (Step 7) the depth of the dent; (Step 8) the composition of the materials in the panel; (Step 9) the number of body lines launched or erased; (Step 10) whether the dent is over a brace; (Step 11) whether bracing glue will need to be removed or replaced; (Step 12) whether the dent has a crease in it; (Step 13) whether the dent is over a double body panel; (Step 14) whether the dent is within an inch of the panel's edge; (Step 15) and whether there are other additional difficulties that should be accounted for by the System. In this embodiment, a System would then calculate the cost adjustments based on the difficulty factors (Step 16).

The System may also prompt the Estimator to input whether there are other dents on the panel in question (Step 17). If yes, the process in FIG. 1 may be repeated for the additional dent(s).

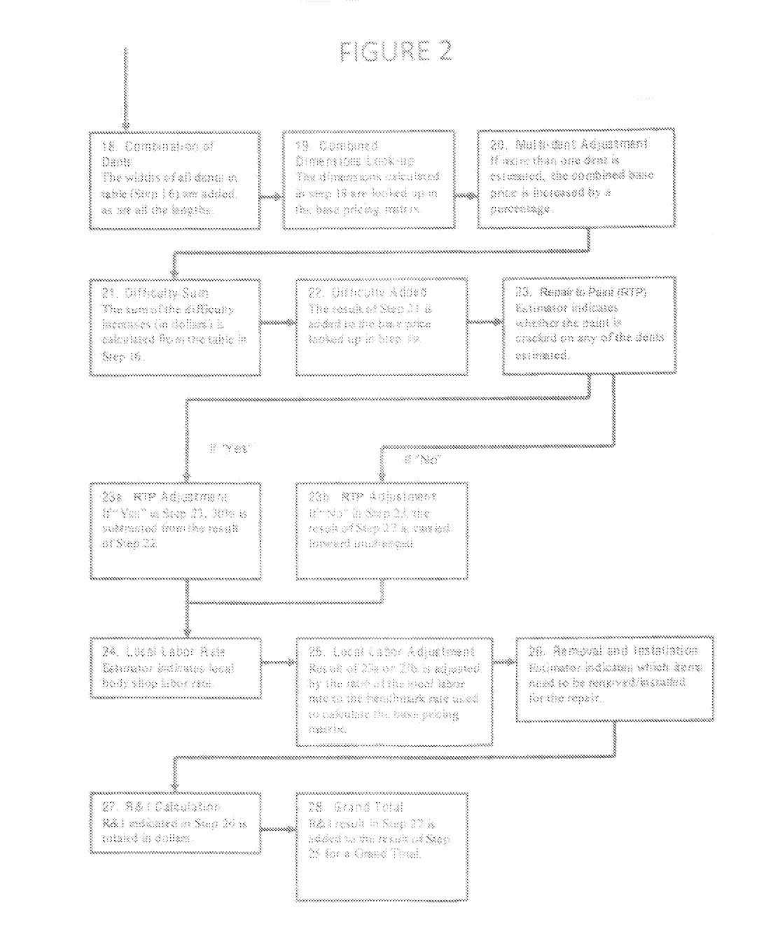

FIG. 2 is a flow chart of sample steps 18-28 performed by the System, illustrating sample information and input used in estimating the costs to repair an Irregular Dent with PDR. These sample steps include, without limitation: (Step 18) calculating a repair estimate based on a variety of different sized dents on the same panel; (Step 19) adjusting. the estimate based on the combined dimensions of dents; and (Step 20) adjusting the estimate by the total number of dents to be repaired on the panel.

Finally, an embodiment of the System may adjust the repair estimate based on: (Steps 23a and 23b) whether repainting is required or not; (Steps 24 and 25) the local labor rate; and (Steps 26 and 27) additional part removal and installation (“R&I”) services required. The System then prepares a report including the grand total of the repair estimate.

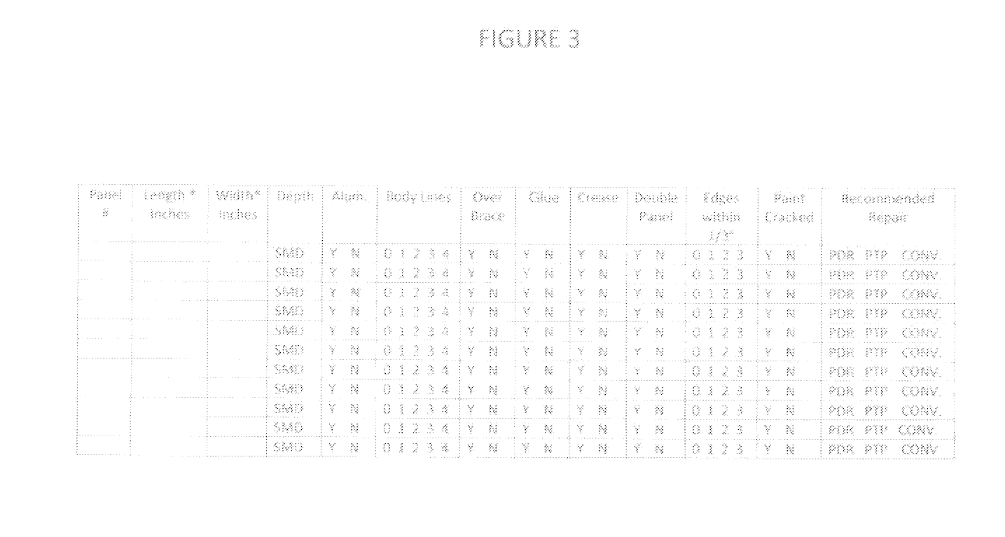

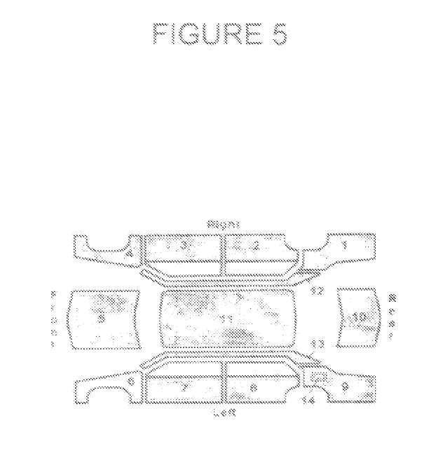

FIG. 3 is an information table illustrating some difficulty factors that may be presented to an Estimator by the System in one embodiment of the invention. The column headings correspond to the sample steps described in the flow charts shown in FIGS. 1 and 2, as follows: “Panel #”—FIG. 1, Step 1 (which may be a numerical value for the panel as illustrated in. FIG. 5); “Length”—FIG. 1, Step 2; “Width”—FIG. 1, Step 3; “Alum.”—FIG. 1, Step 8; “Body Lines”—FIG. 1, Step 9; “Over Brace”—FIG. 1, Step 10; “Glue”—FIGURE. 1, Step 11; “Crease”—FIG. 1, Step 12; “Double Panel”—FIG. 1, Step 13; “Edges within ⅓″”, —FIG. 1, Step 14; and “Paint Cracked”—FIG. 2, Step 23.

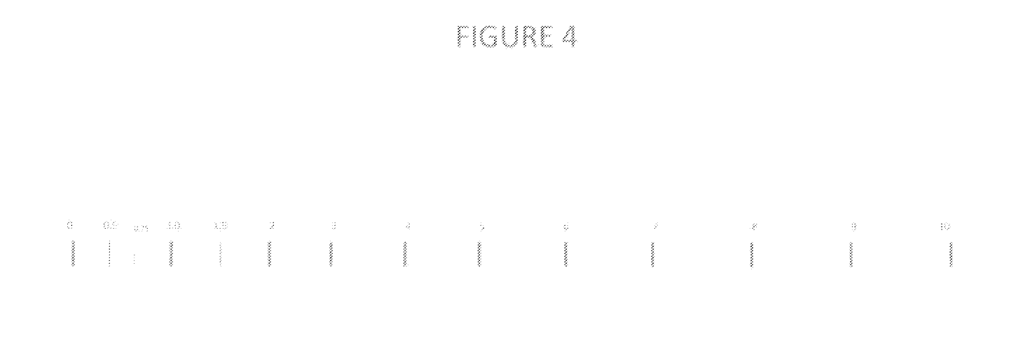

FIG. 4 shows sample measurement options for estimating the depth and or width of a dent when an Estimator is using a System. Any standard measurement device may be used. Further, any system of measurement may be used, including, without limitation. Society of Automotive Engineers (SAE) and Metric systems. The sample measurement options shown are selected based on how an Estimator may round the measurement to the nearest value having significance in one embodiment of the System. For example, in one embodiment of the system the Estimator may enter a value for a dent measuring 0.6 inches wide as being recognized as 0.75 inches and a dent of 5.1 inches long as being recognized 5 inches.

FIG. 5 is an exploded top two-dimensional view of panels comprising the body of a sample standard automobile with numbered panels identifying front, right, left, and rear panels comprising the body of a sample standard automobile with numbered panels (1) a right quarter panel; (2) a right rear door panel; (3) a right front door panel; (4) a right fender panel; (5) a hood panel; (6) a left fender panel; (7) a left front door panel; (8) a left rear door panel; (9) a left quarter panel; (10) a deck lid panel; (11) a roof panel; (12) a top right rail panel; (13) a top left rail panel; and (14) a gas cap cover panel.

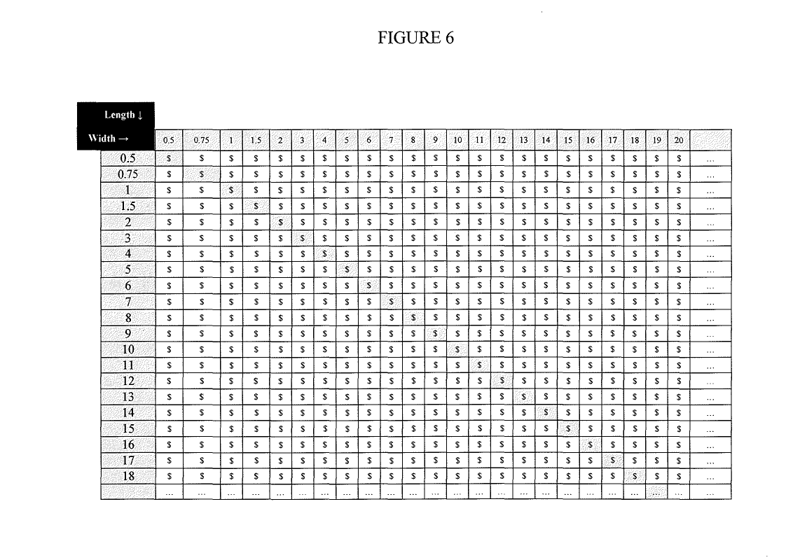

FIG. 6 is a sample spreadsheet representative of a dent estimator database used to provide the baseline repair pricing estimate data for the System. Each row of the table corresponds to the width, in inches, of the Irregular Dent while each column of the table corresponds to the length of the dent. The database may contain additional information, including, without limitation, additional widths and lengths. For a dent that is 5 inches wide by 10 inches long, the System's database stores a value which may be a price or a repair time.

In the foregoing description, it will be readily appreciated by those skilled in the art that modifications may be made to the invention without departing from the concepts disclosed herein. Such modifications may include a System for estimation of repair costs for PDR for Irregular Dents in various sheet metal objects, including, but not limited to, to metal caskets, household and commercial appliances, airplanes, metal furniture, metal cookware, watercraft, recreational vehicles, and recreational vehicle trailers (e.g., Airstream trailers). Such modifications are to be considered as included in the following claims, unless the claims by their language expressly state otherwise.

The invention claimed is:

1. (canceled)

2. A computer-implemented method for estimating the cost of repairing a dent using PDR, comprising:
receiving the make and model of a damaged vehicle;
receiving the location of the dent on the vehicle;
receiving the two-dimensional length and width of a dent;
determining the estimated cost to fix the dent using PDR; and
presenting the estimate to the user.

3. The method of claim 2, wherein the method further comprises estimating the estimated cost required to fix the dent using PDR based on an hourly rate.

4. The method of claim 2, wherein the estimate is adjusted based on certain difficulty factors about the dent entered by the user.

5. The method of claim 2, further comprising obtaining vehicle repair instructions, from at least one database, which instructions are required for repair of the dent; and
presenting the instructions to a third party PDR technician or the user.

6. The method of claim 2, wherein the estimate is adjusted based on certain difficulty factors associated with the location of the dent on the vehicle.

7. The method of claim 2, further comprising
receiving photos of the damaged vehicle: and
determining the make and model of the vehicle from the photos.

8. The method of claim 2, further comprising
receiving photos of the dent and the damaged vehicle;
determining the make and model of the vehicle from the photos; and
determining difficulty factors based on the location and size of the dent as depicted in the photos.

9. The method of claim 2, wherein the estimate is adjusted when painting is required after PDR, based on the additional cost of painting.

10. A computer system comprising
at least one user device;
means for receiving user generated information about a dent;
means for storing information about PDR dent repair times and costs based on historical repairs,
means for processing program instructions to estimate the costs of repairing said dent based on said historical information: and
means for sending the repair estimate back to the user device.

11. The computer system of claim 10, further comprising a means for sending the cost estimate to a PDR technician.

12. The computer system of claim 10, further comprising a means for adjusting the cost estimate for difficulty factors related to the location of the dent on the vehicle.

13. The computer system of claim 10, further comprising means for adjusting the cost estimate based on the depth or height of the dent.

14. The computer system of claim 10, further comprising means for determining the make and model of a vehicle or vehicle identification number from photographs submitted by the user device or by scanning the vehicle identification number with a user device.

15. The computer system of claim 10, wherein the computer system is a mobile device, personal computer, or other electronic device.

16. The computer system of claim 10, further comprising a means for scheduling a repair with a PDR technician.
